(19) United States
(12) Patent Application Publication
(10) Pub. No.: US 2016/0005523 A1
(43) Pub. Date: Jan. 7, 2016

(54) POTTED HEAT TRANSFER MEDIA TRANSFORMER SYSTEM

(71) Applicant: Louw D. Jacobs, Oxnard, CA (US)

(72) Inventor: Louw D. Jacobs, Oxnard, CA (US)

(21) Appl. No.: 14/793,394

(22) Filed: Jul. 7, 2015

Related U.S. Application Data
(60) Provisional application No. 62/021,302, filed on Jul. 7, 2014.

(51) Int. Cl. H01F 27/16; H01F 41/02; H01F 27/02; H01F 41/00; H01F 27/24; H01F 27/28

(52) U.S. Cl. CPC H01F 27/16; H01F 27/24; H01F 27/28; H01F 27/022; H01F 27/025; H01F 41/005; H01F 41/02

(57) ABSTRACT

A transformer system comprises various transformer components (e.g., coils, cores, rectifiers, connectors, etc.) enclosed in a housing. The transformer system can be cooled by various heat transfer methods routed through the enclosure. Some or all of the transformer components are potted in epoxy. The transformer system is suitable for any kind of environment—explosive, corrosive, even deliberate and or accidental emersion of the system into fresh or salt water, acids and explosive media. In some examples, a transformer system includes of an efficiently cooled transformer having (in one example) a switching power supply, SCR drive system and/or combined with a rectification component (e.g., MOSFET devices), a solid-state analog or digital control system, and/or integrated and passive components and circuits.

### CROSS-REFERENCE TO RELATED APPLICATION(S)

This is a conversion of and claims a benefit of priority from U.S. Provisional Application No. 62/021,302, filed Jul. 7, 2014, entitled “POTTED HEAT TRANSFER MEDIA TRANSFORMER SYSTEM,” which is hereby incorporated by reference as if set forth herein in its entirety.

### FIELD OF THE INVENTION

The present disclosure relates to electrical transformers and the like. More specifically, the disclosure relates to an apparatus and methods for super cooling of electrical transformers and components resulting in smaller footprint, lighter, modular, stackable more robust and corrosion free equipment with a lower operating temperature.

### BACKGROUND OF THE INVENTION

Transformers are used in the distribution of electrical power to transform power into suitable currents and voltages for transportation over power distribution systems. Typically, when transmitting electrical power over large distances, it is common to raise the voltage using transformers to reduce power loss. Likewise, the high voltage is transformed into a lower voltage when received.

A power distribution transformer can generate a lot of heat. Typical prior art transformers may be air cooled (forced or natural) or oil cooled (forced or natural). Other prior art transformers use cast resin coils. A transformer basically comprises high voltage windings, low voltage windings, an iron core for circulation of the magnetic flow, connections among the windings and connection terminals. Typically, all of the transformer components encased inside a metal enclosure and submerged in oil.

FIGS. 1-3 show examples of typical prior art transformers. FIG. 1 is a view of an oil cooled transformer and/or rectifier. FIG. 2 is a view of an air cooled transformer and/or rectifier. FIG. 3 shows various views of a typical cast resin coil transformer and/or rectifier. Typical prior art transformers are subject to various problems, including corrosion, a large size, calcium buildup, environmental exposure, harmful and or explosive gasses, and electrical shock.

While some prior art transformers use potted (encapsulated) components, a transformer system described herein overcomes problems in the prior art. The design and method of implementing an imbedded cooling system allows for conductors to operate at a much higher current density, in turn reducing the size of the equipment, and also making the equipment safe to be placed in any kind of environment without the need to incorporate special high cost enclosures, sub-stations, spill containment, bushings and or overhead wires. The transformer system described below enables an electrically safe, environmentally friendly, recyclable, biodegradable alternative to prior art systems, extending the life of the equipment. The system is braced against shock, vibration, lightning, harsh environmental conditions, corrosive, combustive and explosive water, chemical and gas laden atmospheres.

### SUMMARY OF THE INVENTION

A transformer system is provided including a housing, transformer components disposed within the housing, a cooling component disposed at least partially within the housing proximate the transformer components, the cooling component including one or more conduits for containing heat transfer media, and an epoxy potting material encapsulating at least some of the transformer components and at least some of the cooling component.

Another embodiment provides a method of forming a transformer system including providing a housing, placing transformer components within the housing, placing a cooling component within the housing at least partially around the transformer components to circulate heat transfer media through the cooling component, and encapsulating at least some of the transformer components and at least some of the cooling component with an epoxy material.

Other features and advantages of the present disclosure will be apparent from the accompanying drawings and from the detailed description that follows below.

Other features and advantages of the present disclosure will be apparent from the accompanying drawings and from the detailed description that follows below.

### BRIEF DESCRIPTION OF THE DRAWINGS

FIG. 1 is a view of an oil cooled transformer and or rectifier.

FIG. 2 is a view of an air cooled transformer and or rectifier.

FIG. 3 shows various views of a typical cast resin coil transformer and or rectifier.

FIGS. 4A-4E show various views of a water cooled transformer and or rectifier system.

FIGS. 5A-5C show views of exemplary transformer system layouts.

FIGS. 6A-6B show views of exemplary transformer system layouts, including the routing of heat transfer media or other heat exchangers if required.

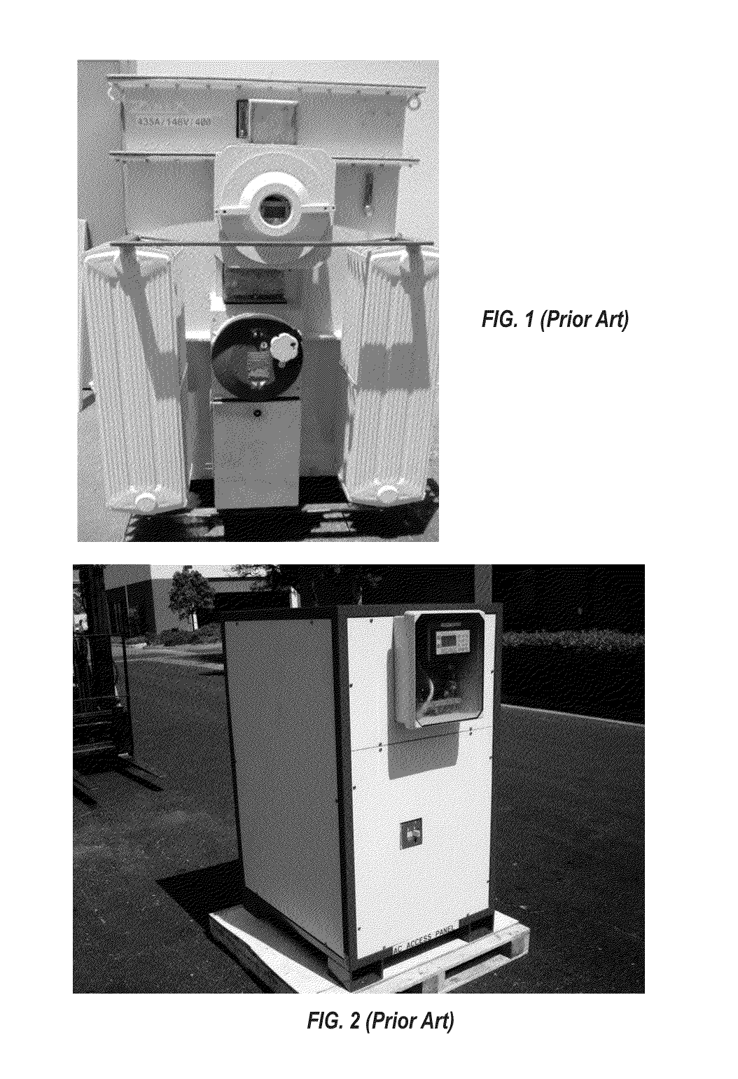

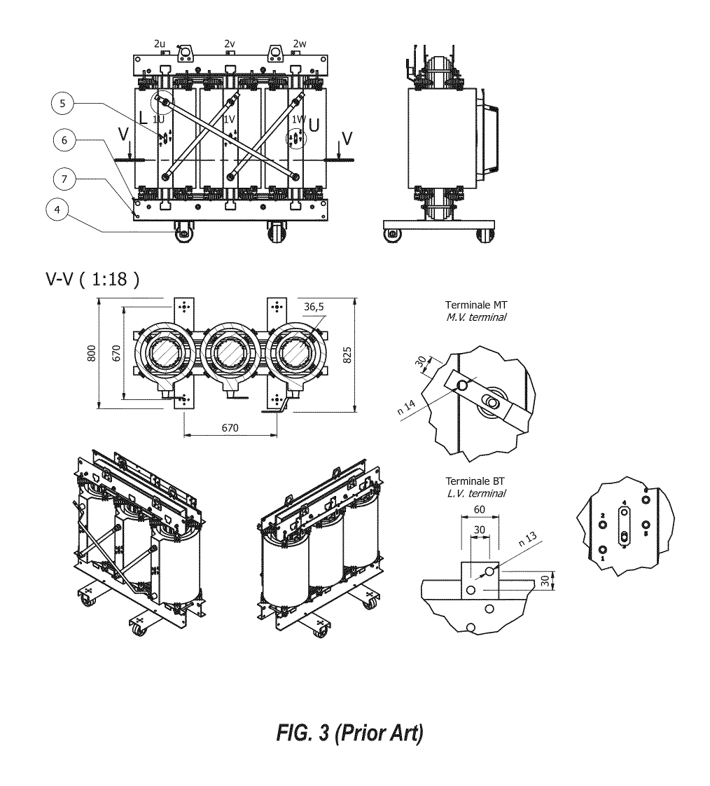

### DETAILED DESCRIPTION

Generally, a transformer described below comprises various transformer components (e.g., coils, cores, rectifiers, connectors, etc.) enclosed in a housing. The transformer is cooled by various heat transfer methods routed through the enclosure. Some or all of the transformer components are potted in epoxy.

The transformer system described in this disclosure resolves and overcome problems with the prior art, rendering equipment using the transformer system suitable for any kind of environment—explosive, corrosive, even deliberate and or accidental emersion of the system into fresh or salt water, acids and explosive media.

In some embodiments, a transformer consists of an efficiently cooled “transformer” having (in one example) a switching power supply, SCR drive system and/or combined with a rectification component (e.g., MOSFET devices), and a solid-state analog or digital control system (e.g., a digital micro controller), and/or integrated and passive components and circuits. A transformer may include any other types of combinations of components.

The components of the transformer are carefully placed inside a polymer plastic or metal enclosure. In some examples, suitable enclosures include stainless steel and/or Titanium. Some of or all of the transformer components are surrounded by an integrated stainless steel and/or titanium heat transfer media cooled system (described below). The heat transfer media may include water, and other suitable media. The media cooling system can be coupled in parallel, series or as a stand-alone cooling system using, for example, fresh or salt water or a closed loop liquid coolant and/or refrigeration system. The media cooling system will be referred to below as the “cooling component” of the transformer system.

Following the placement of the transformer components and the cooling component, the entire assembly (hereinafter referred to as the “block”) is potted with epoxy (e.g., silicone) containing a suitable amount of silica (e.g., aluminum oxide) hereinafter referred to as the “compound” in order to promote the thermal conductivity of the compound and the transfer of heat via the compound to the cooling component. In some embodiments, compounds used system are UL94-V0 fire retardant with desirable thermal conductivity and dielectric properties. The compound may also have a very high dielectric strength making the system suitable for very high voltage applications.

One challenge with the transformer system is that the electronics required to change the voltage of the equipment in prior art systems is done by switching a resistive circuit (for example, a 9-position switch) which in turn summarize the values to optimize the control circuit. This method is less practical to implement in the encapsulated transformer system. To overcome this challenge, circuitry is used that memorizes the resistive values, and more specifically, can be changed by means of a computerized value setting that can be changed and memorized by the integrated circuit. As a result, needed adjustments can be made even while the various components are encapsulated in the epoxy.

In conjunction with this challenge and solution, the challenge of the calibration of components has to be addressed as well. This challenge is overcome by designing electronics using an analog or digital adjustment computer having a serial port (or other type of interface) and/or via a wireless interface. A non-exclusive list of types of suitable interface standards include modbus, internet, canbus, ethernet, RS-485, RS-232, profibus, etc. With respect to remotely configuring the system or calibrating the system, any suitable interface card, trigger board (each described below), and remote calibrator may be used, as one skilled in the art would understand. These functions can be implemented in any desired manner, as one skilled in the art would understand.

One suitable trigger board is the Zinex™ trigger board part number Z6555, manufactured by Zinex™ Corporation, Inc. One suitable interface card is the Zinex™ interface card part number 1-16555, manufactured by Zinex™ Corporation, Inc. This interface card expands the inputs and outputs of the Z6555 trigger board. One use of the interface card is to make the trigger board controlled by a PLC; although other uses are possible due to the flexibility of the Interface card.

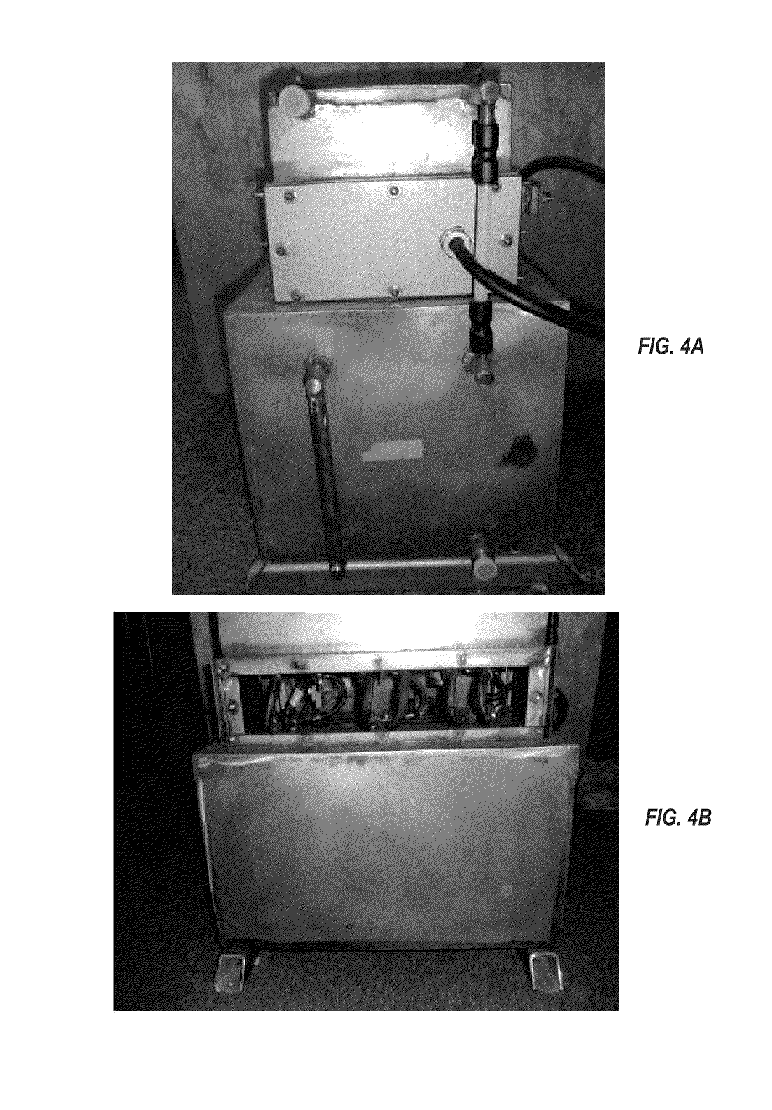

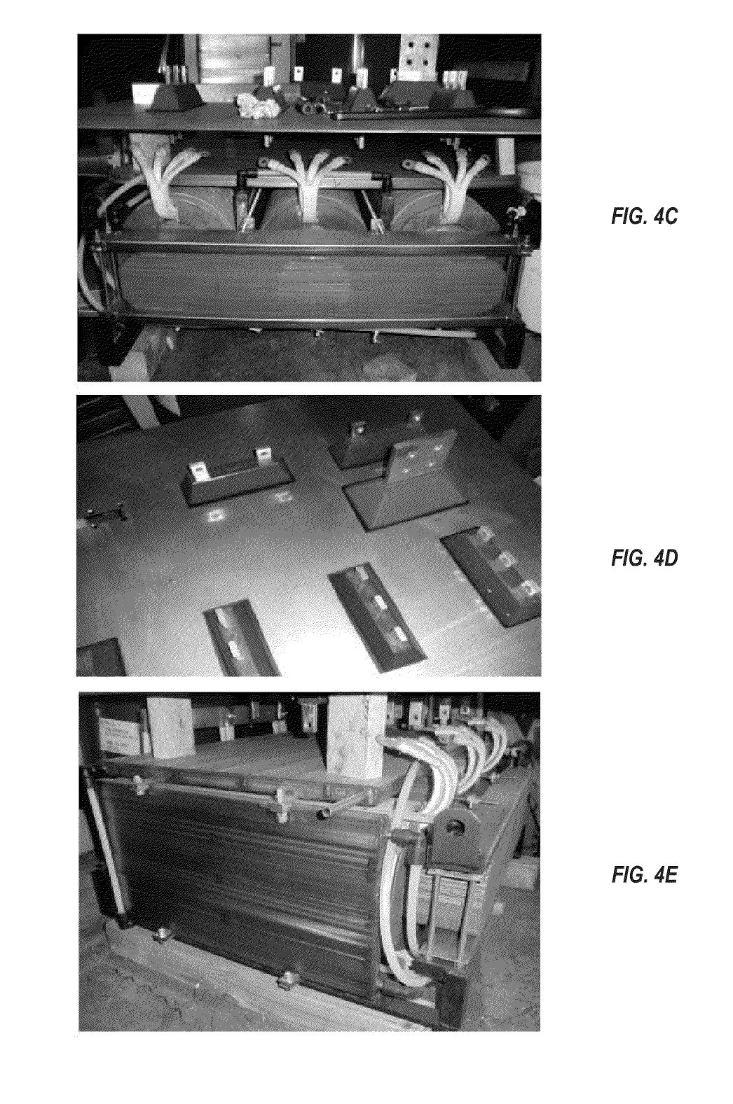

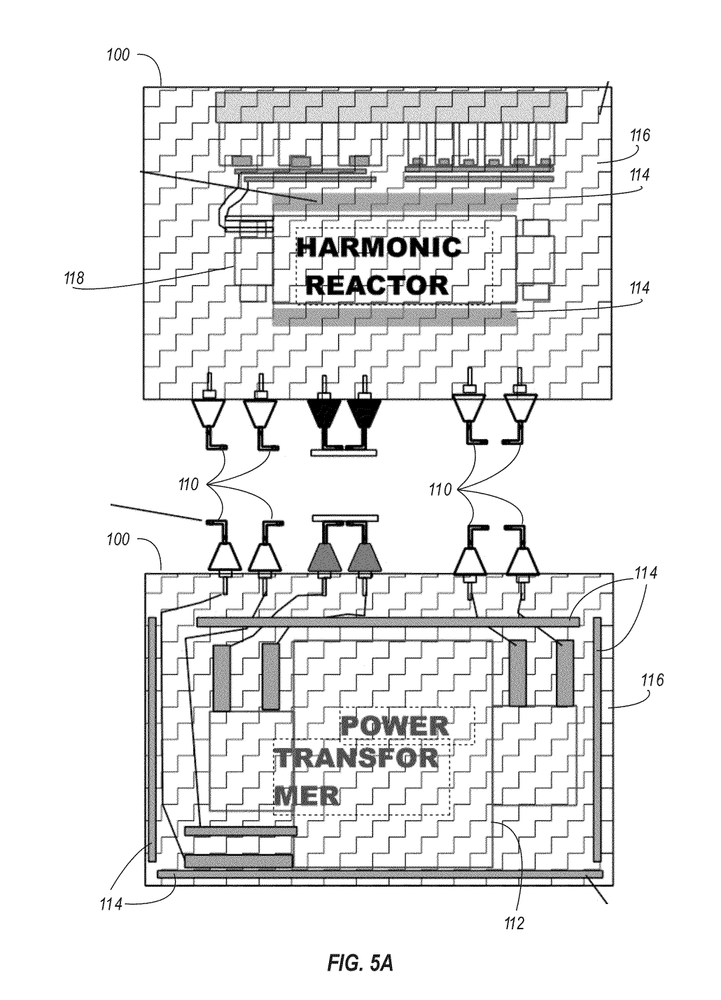

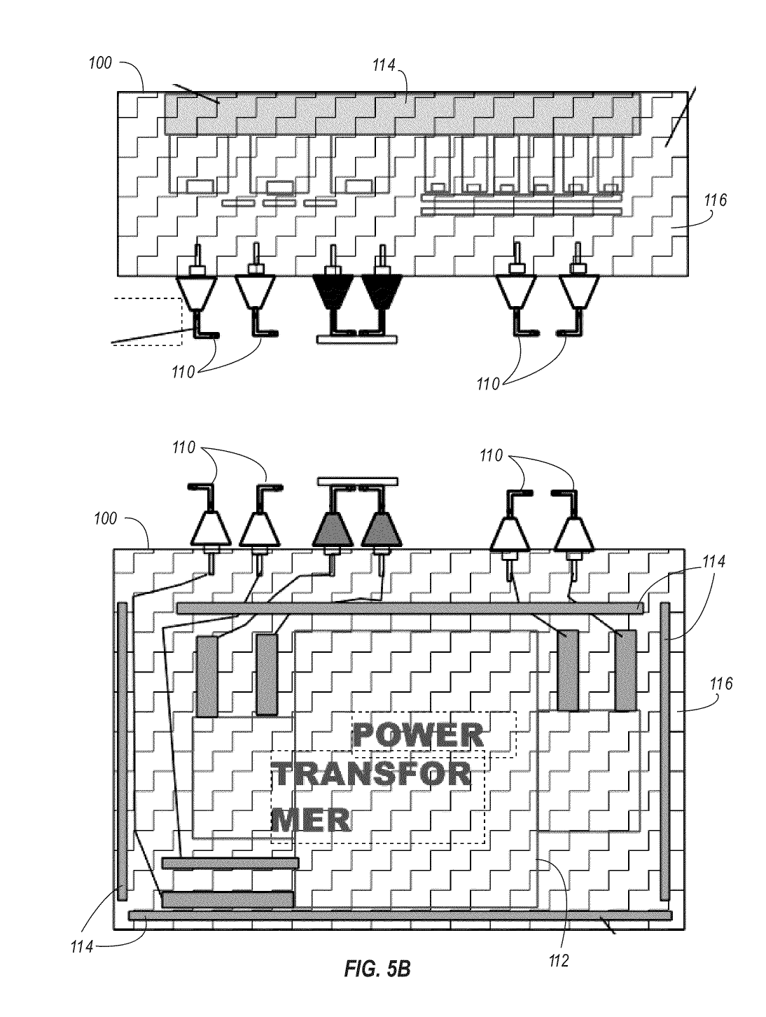

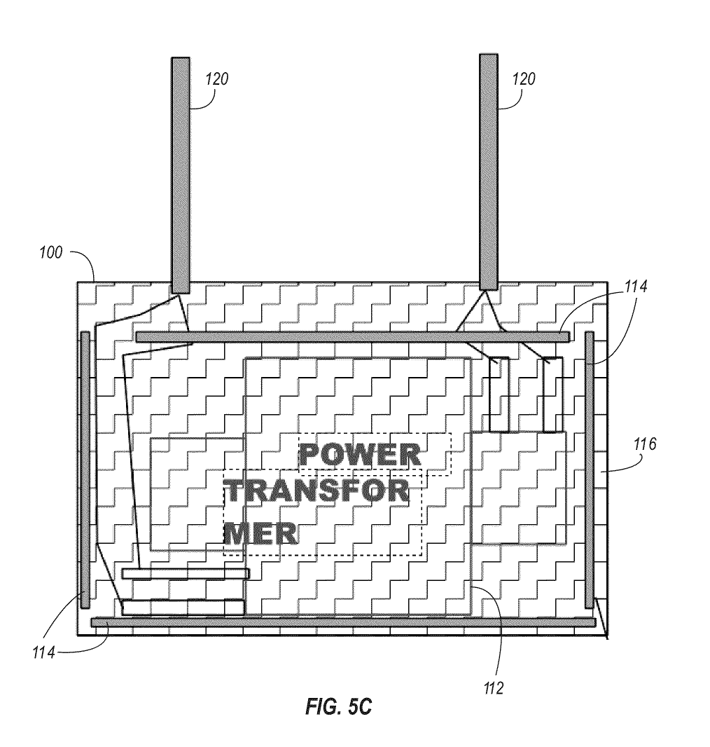

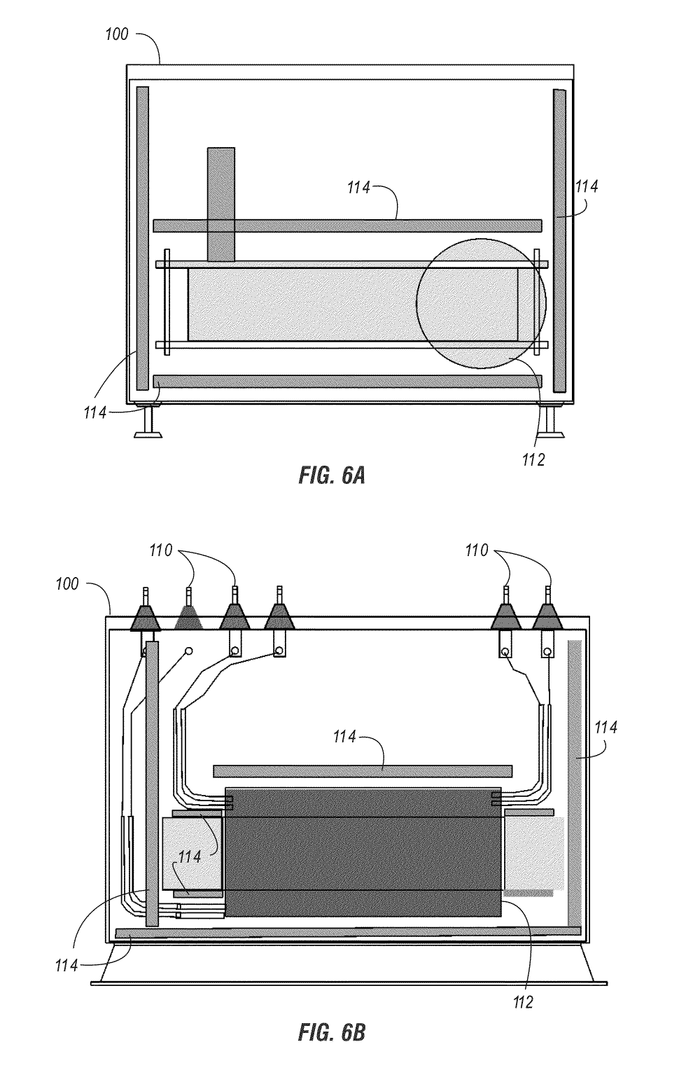

FIGS. 4A-4E show various isometric views of an exemplary transformer and/or rectifier system. FIGS. 5-6 show examples of the layout of a transformer system, including the system components and cooling component. The examples provided are described in the context of power distribution transformers that are cooled by means of heat transfer. Other examples and other applications are also possible.

FIGS. 5A-5C show a first example of a system layout. In these examples FIG. 5A shows low harmonic components, while FIG. 5B shows standard six pulse components. In FIG. 5A-5C, a housing, or enclosure 100 encloses various components. The system includes a plurality of input/output terminals 110 that are used to electrically connect the various components of the system with the outside world (e.g., the grid).

The bottom portion of FIG. 5A shows a sectional view of a power transformer 112 disposed within the housing 100. Various terminals of the power transformer 112 are electrically connected to the input/output terminals 110. A plurality of heat exchange components 114 (i.e., heat transfer jackets) are disposed around the power transformer 112, as shown. During use, (heat transfer media) is pumped through the exchange components 114 to keep the transformer system cool. As illustrated by the shading, a vacuum filled epoxy resin 116 (illustrated by the shading/cross hatching) is disposed in the housing, encapsulating all of the components and the cooling component. The upper portion of FIG. 5A shows (for example but not limited to) a harmonic reactor 118 disposed in the housing 100. The harmonic reactor 118 is also surrounded by heat exchange components 114 to keep the reactor 118 cool.

The bottom portion of FIG. 5B shows a sectional view of a power transformer 112 disposed within the housing 100. Various terminals of the power transformer 112 are electrically connected to the input/output terminals 110 (for example, electrical cables could be implemented instead). A plurality of heat exchange components 114 (i.e., heat transfer media) are disposed around the power transformer 112, as shown. During use, heat transfer media is pumped through the exchange components 114 to keep the transformer system cool. As illustrated by the shading, a vacuum filled epoxy resin 116 is disposed in the housing, encapsulating all of the components and the cooling component. The upper portion of FIG. 5B shows other components of the system, which are encapsulated by epoxy 116 and cooled by exchange components 114.

FIG. 5C shows a sectional view of a power transformer 112 disposed within the housing 100, including a cable entry system 120. The cable entry system may be comprised of electrical conduit/cables, etc.

FIGS. 6A and 6B show views of another example of a transformer system. As before, FIGS. 6A and 6B shows a sectional view of a power transformer 112 disposed within a housing 100. For clarity, FIGS. 6A and 6B do not show the epoxy. FIG. 6A is an end view of the system, and FIG. 6B is a side view of the system. FIGS. 6A-6B illustrates the routing of heat transfer media or other heat exchangers, if required.

The transformer system described above has numerous advantages over other systems, as described below. The transformer system has a smaller footprint and overall size compared to typical available systems The transformer system provides the ability to be sealed against corrosive, explosive and water laden atmospheres. The transformer system can be designed to meet NEC500/505 standards, as well as to meet the IECEx and ATEX specifications for Zone 0, I, II, 20, 21 & 22 with an IP66/67 rating. The transformer system eliminates the need for very expensive NEMA 7X enclosures or ATEX/IECEx flameproof enclosures. The transformer system meets T4/6 temperature ratings as per IECEx and ATEX specifications. The transformer system allows for modular plug in plug out construction. The transformer system allows for stackable construction of multiple units in parallel with a common intricate control system. The transformer system can operate in volatile explosive areas. The transformer system has no limit to current, voltage & power (mille amp to Kilo amp) (mille volt to kilo volts) (Watt to Mega Watt), etc. The transformer system is resistant to lightning strikes. The transformer system is environmentally friendly, with no PCB's, no oil, and no contamination of water ways. All components of the transformer system are environment friendly.

The transformer system technology described above opens the entire power industry (medium to mega power systems) to not only making smaller equipment, but eliminating PCB's, oil, and making the equipment safer, for example by being used in high voltage distribution transformers. Many typical transformers utilize transformer oils and or synthetic oils for their dielectric and cooling properties.

Further, the transformer system also eliminates the need for high voltage bushings (insulators) when transferring incoming and or outgoing power to the grid. The transformer system allows for high voltage systems to be placed in the open (free standing and/or underground) with all the cabling being terminated directly from the transformer system (internally) to the grid. The commercial impact and cost saving is vast in every aspect of industry in applications were heat dissipation impacts the feasibility size and cost.

In the preceding detailed description, the disclosure is described with reference to specific exemplary embodiments thereof Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A transformer system comprising:
a housing;
transformer components disposed within the housing;
a cooling component disposed at least partially within the housing proximate the transformer components, the cooling component including one or more conduits for containing heat transfer media; and
an epoxy potting material encapsulating at least some of the transformer components and at least some of the cooling component.

2. The transformer system of claim 1, wherein the transformer components include one or more of coils, cores, rectifiers, and connectors.

3. The transformer system of claim 1, wherein the heat transfer media is comprised of water.

4. The transformer system of claim 1, wherein the heat transfer media is a refrigeration system liquid coolant.

5. The transformer system of claim 1, wherein the epoxy potting material contains aluminum oxide.

6. The transformer system of claim 1, wherein the housing is comprised of a polymer material.

7. The transformer system of claim 1, wherein the housing is comprised of a metal enclosure.

8. A method of forming a transformer system comprising:
providing a housing;
placing transformer components within the housing;
placing a cooling component within the housing at least partially around the transformer components to circulate heat transfer media through the cooling component; and
encapsulating at least some of the transformer components and at least some of the cooling component with an epoxy material.

9. The method of claim 8, wherein the transformer components include one or more of coils, cores, rectifiers, and connectors.

10. The method of claim 8, wherein the heat transfer media is comprised of water.

11. The method of claim 8, wherein the heat transfer media is a refrigeration system liquid coolant.

12. The method of claim 8, wherein the epoxy material contains aluminum oxide.

13. The method of claim 8, wherein the housing is comprised of a polymer material.

14. The method of claim 8, wherein the housing is comprised of a metal enclosure.
